(19) United States
(12) Patent Application Publication
(10) Pub. No.: US 2017/0206580 A1
(43) Pub. Date: Jul. 20, 2017

(54) MERCHANDISE RETRIEVAL DEVICE AND MERCHANDISE RETRIEVAL METHOD

(71) Applicant: FUJIFILM Corporation, Tokyo (JP)

(72) Inventor: Makoto YONAHA, Tokyo (JP)

(73) Assignee: FUJIFILM Corporation, Tokyo (JP)

(21) Appl. No.: 15/473,616

(22) Filed: Mar. 30, 2017

Related U.S. Application Data
(63) Continuation of application No. PCT/JP2015/077126, filed on Sep. 25, 2015.

(30) Foreign Application Priority Data
Nov. 11, 2014 (JP) 2014-229237

(51) Int. Cl. G06Q 30/06; G06F 17/30

(52) U.S. Cl. CPC G06Q 30/0627; G06F 17/30256

(57) ABSTRACT

The merchandise retrieval device includes a first retrieval unit (41) that analyzes a retrieval condition image to acquire first retrieval condition data indicating a design feature of a retrieval condition image, and retrieves a plurality of first retrieval images from a plurality of merchandise images stored in a database (32) based on first retrieval condition data, and a second retrieval unit (42) that retrieves second retrieval images from the first retrieval images based on second retrieval condition data designated as being related to the design feature through a user terminal. The first retrieval unit (41) retrieves the first retrieval images included in a first retrieval range in a feature space representing the design feature. The second retrieval unit (42) retrieves the second retrieval images included in a second retrieval range in the feature space. The first retrieval range is larger than the second retrieval range.

### CROSS-REFERENCE TO RELATED APPLICATIONS

This application is a Continuation of PCT International Application No. PCT/JP2015/077126 filed on Sep. 25, 2015, which claims priority under 35 U.S.C §119(a) to Patent Application No. 2014-229237 filed in Japan on Nov. 11, 2014, all of which are hereby expressly incorporated by reference into the present application.

### BACKGROUND OF THE INVENTION

1. Field of the Invention

The present invention relates to a merchandise retrieval device and a merchandise retrieval method, and particularly, to a merchandise retrieval device and a merchandise retrieval method which retrieve desired merchandise images from a plurality of merchandise images.

2. Description of the Related Art

In a case where merchandise such as clothes is retrieved on an electronic commerce (EC) site on the Internet, pieces of merchandise may be generally narrowed down by designating price, size, and color. For example, if a user designates color of desired clothes on a web page, a list of clothes images related to the designated color is displayed. The user selects a desired image from the displayed list of clothes images, and can purchase clothes of the selected image.

As stated above, in order to retrieve desired merchandise from an enormous merchandise group, it is necessary to specify and use a retrieval key indicating a feature of the desired merchandise, but a design such as color of the merchandise is a sensuous feature, and it is not necessarily easy to strictly express and specify such a design feature. For example, if it is assumed that the desired merchandise has a reddish color as a key, various kinds of colors are strictly classified into reddish colors. Thus, in a case where the merchandise having a certain specific color of the reddish colors as a key is requested as the desired merchandise, a user who does not have special knowledge is not able to appropriately specify the specific color as the retrieval key, and thus, it is necessary to retrieve the desired merchandise from a plurality of pieces of merchandise having the reddish colors. As a result, the desired merchandise is not able to be found.

A technology for acquiring the retrieval key through image analysis in order to enable the retrieval of the desired merchandise even in the above-described case where the feature of the desired merchandise is not able to be expressed has been known. For example, in a retrieval guidance system disclosed in JP2003-122757A, the user images an image of a desired product by using a terminal device, and feature information acquired by analyzing the imaged image data is used as the retrieval key. According to the retrieval guidance system, if the user can image the image of the desired product, the user can acquire detailed information regarding the product even though the user does not ascertain detailed information such as a name of the product.

A technology for performing a multi-stage retrieval process in order to efficiently retrieve the desired merchandise from the enormous merchandise group has been known. For example, an image retrieval process based on a “global feature” including at least one of the entire shape, color, or texture of the merchandise and an image retrieval process based on a “local feature” including at least one of a partial shape, size, number, position, color, or texture of the merchandise are performed in a content retrieval device disclosed in JP2014-191588A. According to the content retrieval device, images of pieces of merchandise including a feature similar to a local feature of a second image are retrieved after images of pieces of merchandise including a feature similar to a global feature of a first image are retrieved, and thus, pieces of merchandise of which the entire or partial design is similar to the merchandise desired by the user can be efficiently retrieved.

### SUMMARY OF THE INVENTION

In a merchandise retrieval technology using the retrieval key acquired through the image analysis like the retrieval guidance system disclosed in JP2003-122757A, it is difficult to maintain retrieval accuracy at a high level. That is, it is necessary to use an appropriate retrieval key in the retrieving in order to retrieve the merchandise with high accuracy, but an analysis result greatly depends on a state or analysis accuracy of an image of an analysis target in a case where the retrieval key is acquired through the image analysis. Thus, it is easy to fundamentally cause an error in the retrieval key acquired through the image analysis, and thus, it is considerably difficult for a retrieval key desired by the user to completely match the retrieval key acquired through the image analysis in reality at all times.

Even in a merchandise retrieval technology for narrowing down pieces of target merchandise by performing the multi-stage retrieval process like the content retrieval device disclosed in JP2014-191588A, it is necessary to specify an appropriate retrieval key in order to retrieve the merchandise with high accuracy. However, even in a case where the multi-stage retrieval process is performed, it is necessary to appropriately specify the design feature such as the color of the desired merchandise as in the related arts. Even in such a case, it is not necessarily easy to accurately specify the design feature which is the sensuous feature.

In such an existing system, the retrieval accuracy is not necessarily sufficient, and it is difficult for the user who does not have the specialized knowledge to accurately specify the sensuous design feature of the desired merchandise as the retrieval key. Thus, it is a low convenience in using such an existing system. Thus, it may take much time for the user to find the desired merchandise from the enormous merchandise group, and the user may not find the desired merchandise at the end even though the desired merchandise is included in the merchandise group of the retrieval targets.

The present invention has been made in view of the above-described circumstances, and it is an object of the present invention to provide a merchandise retrieval method capable of conveniently and accurately find desired merchandise images from a plurality of merchandise images, and an application technology.

According to an aspect of the present invention, there is provided a merchandise retrieval device that is connected to a user terminal via a network. The device comprises: a first retrieval unit that analyzes a retrieval condition image to acquire first retrieval condition data indicating a design feature of the retrieval condition image, and retrieves a plurality of first retrieval images from a plurality of merchandise images stored in a database based on the first retrieval condition data; and a second retrieval unit that retrieves second retrieval images from the plurality of first retrieval images based on second retrieval condition data designated as being related to the design feature through the user terminal. The first retrieval unit retrieves images having the design feature, which are included in a first retrieval range determined using the first retrieval condition data as a criterion in a feature space representing the design feature, from the plurality of merchandise images, as the first retrieval images, the second retrieval unit retrieves images having the design feature, which are included in a second retrieval range determined using the second retrieval condition data as a criterion in the feature space, from the plurality of first retrieval images, as the second retrieval images, and the first retrieval range is larger than the second retrieval range.

According to the present aspect, the plurality of first retrieval images can be conveniently retrieved from the plurality of merchandise images based on the first retrieval condition data acquired by analyzing the retrieval condition image, and the second retrieval images can be accurately retrieved based on the second retrieval condition data designated through the user terminal. Particularly, the first retrieval range is larger than the second retrieval range, and thus, desired merchandise images can be effectively included in the plurality of first retrieval images even though there is an error in the first retrieval condition data acquired by analyzing the retrieval condition image. The second retrieval range is smaller than the first retrieval range, and thus, the second retrieval images can be efficiently narrowed down to the desired merchandise images.

Preferably, the design feature is a feature regarding at least one design element. That is, the design feature may be a feature regarding one design element, or may be features regarding a plurality of design elements.

According to the present aspect, the plurality of first retrieval images and the plurality of second retrieval images can be retrieved based on the feature regarding at least one design element.

Preferably, the design element is based on at least one of color, a pattern, a shape, or texture.

According to the present aspect, the plurality of first retrieval images and the plurality of second retrieval images can be retrieved with the feature regarding the design element based on at least one of the color, pattern, shape, or texture as a basis.

Preferably, the second retrieval range is equal to or less than 50% of the first retrieval range.

According to the present aspect, retrieval accuracy is improved, and thus, the second retrieval images can be efficiently narrowed down to the desired merchandise images. In order to efficiently narrow down the second retrieval images, the second retrieval range is more preferably equal to or less than 30% of the first retrieval range, and is still more preferably equal to or less than 10% of the first retrieval range.

Preferably, the second retrieval range includes only the design feature equivalent to the second retrieval condition data.

According to the present aspect, the second retrieval images can be very efficiently narrowed down to the desired merchandise images.

Preferably, the user terminal includes an imaging device, and the retrieval condition image is imaged by the imaging device.

According to the present aspect, the plurality of first retrieval images can be conveniently retrieved based on the retrieval condition image imaged by the imaging device.

Preferably, the retrieval condition image is selected from images stored in the user terminal.

According to the present aspect, the plurality of first retrieval images can be conveniently retrieved based on the retrieval condition image selected from the images stored in the user terminal.

Preferably, the user terminal presents some of a plurality of candidates regarding the design feature to a user, and receives at least one design feature designated by the user, and the second retrieval unit determines the second retrieval condition data based on the design feature designated by the user from the plurality of candidates.

According to the present aspect, the second retrieval images can be intuitively and conveniently retrieved based on the design feature designated by the user from the plurality of candidates.

Preferably, the database associates the plurality of merchandise images with metadata items including feature data indicating the design feature of each of the plurality of merchandise images, and stores the associated information items, and the feature data items are acquired by an image analysis unit that analyzes the plurality of merchandise images.

According to the present aspect, the plurality of first retrieval images and the plurality of second retrieval images can be accurately retrieved based on the feature data acquired by analyzing the merchandise images.

Preferably, an external terminal device is connected to the database, and the metadata items stored in the database are able to be corrected through the external terminal device.

Preferably, at least some of the plurality of merchandise images are associated with the metadata items corrected through the external terminal device, and are stored in the database.

According to these present aspects, the accuracy of the feature data items of the plurality of merchandise images can be easily and reliably improved.

According to another aspect of the present invention, there is provided a merchandise retrieval method performed by a merchandise retrieval device connected to a user terminal via a network. the method comprises: a step of analyzing a retrieval condition image to acquire first retrieval condition data indicating a design feature of the retrieval condition image, and retrieving a plurality of first retrieval images from a plurality of merchandise images stored in a database based on the first retrieval condition data; and a step of retrieving second retrieval images from the plurality of first retrieval images based on second retrieval condition data designated as being related to the design feature through the user terminal. Images having the design feature, which are included in a first retrieval range determined using the first retrieval condition data as a criterion in a feature space representing the design feature, are retrieved from the plurality of merchandise images, as the first retrieval images, images having the design feature, which are included in a second retrieval range determined using the second retrieval condition data as a criterion in the feature space, are retrieved from the plurality of first retrieval images, as the second retrieval images, and the first retrieval range is larger than the second retrieval range.

### Advantageous Effects of Invention

According to the present invention, the plurality of first retrieval images can be conveniently retrieved from the plurality of merchandise images based on the first retrieval condition data acquired by analyzing the retrieval condition image, and the second retrieval images can be accurately retrieved based on the second retrieval condition data designated through the user terminal. Particularly, the first retrieval range is larger than the second retrieval range, and thus, desired merchandise images can be effectively included in the plurality of first retrieval images even though there is an error in the first retrieval condition data acquired by analyzing the retrieval condition image. The second retrieval range is smaller than the first retrieval range, and thus, the second retrieval images can be efficiently narrowed down to the desired merchandise images.

### BRIEF DESCRIPTION OF THE DRAWINGS

FIG. 1 is a conceptual diagram of a merchandise retrieval system.

FIG. 2 is a block diagram showing a functional configuration example of a user terminal.

FIG. 3 is a block diagram showing a functional configuration example of a merchandise retrieval device.

FIG. 4 is a conceptual diagram of a data structure showing a correspondence between image data and metadata stored in a database.

FIG. 5 is a conceptual diagram of a data structure showing a configuration data example of the metadata.

FIG. 6 is a block diagram showing a functional configuration example of a retrieval controller.

FIG. 7 is a diagram showing the relationship between a retrieval range using a first retrieval unit and a retrieval range using a second retrieval unit in order to show a one-dimensional feature space represented by a design feature (a first design feature) based on a single design element.

FIG. 8 is another diagram showing the relationship between the retrieval range using the first retrieval unit and the retrieval range using the second retrieval unit in order to show a two-dimensional feature space represented by the design features (a first design feature and a second design feature) based on two types of design elements.

FIG. 9 is still another diagram showing the relationship between the retrieval range using the first retrieval unit and the retrieval range using the second retrieval unit in order to a three-dimensional feature space represented by the design features (a first design feature, a second design feature, and a third design feature) based on three types of design elements.

FIG. 10 is a flowchart showing an example of a processing flow of a merchandise retrieval method performed by a merchandise retrieval device.

FIG. 11 is a flowchart showing an example of a processing flow in the user terminal when a retrieval process of a merchandise image is performed.

FIG. 12 is a diagram showing a display example on a display unit of the user terminal when the retrieval process of the merchandise image is performed.

FIG. 13 is a diagram showing a display example on the display unit of the user terminal when the retrieval process of the merchandise image is performed.

FIG. 14 is a diagram showing a display example on the display unit of the user terminal when the retrieval process of the merchandise image is performed.

FIG. 15 is a diagram showing a display example on the display unit of the user terminal when the retrieval process of the merchandise image is performed.

FIG. 16 is a diagram showing a display example on the display unit of the user terminal when the retrieval process of the merchandise image is performed.

FIG. 17 is a diagram showing a display example on the display unit of the user terminal when the retrieval process of the merchandise image is performed.

FIG. 18 is a diagram showing a display example on the display unit of the user terminal when the retrieval process of the merchandise image is performed.

FIG. 19 is a diagram showing a display example on the display unit of the user terminal when the retrieval process of the merchandise image is performed.

FIG. 20 is a diagram showing an external appearance of a smartphone.

FIG. 21 is a block diagram showing a configuration of the smartphone shown in FIG. 20.

### DESCRIPTION OF THE PREFERRED EMBODIMENTS

An embodiment of the present invention will be described with reference to the drawings. Although an example in which an image is retrieved by using “clothes” as merchandise will be described in the following embodiment, a retrieval target is not limited to the suit, and the present invention may be applied to a case where arbitrary another piece of merchandise is retrieved.

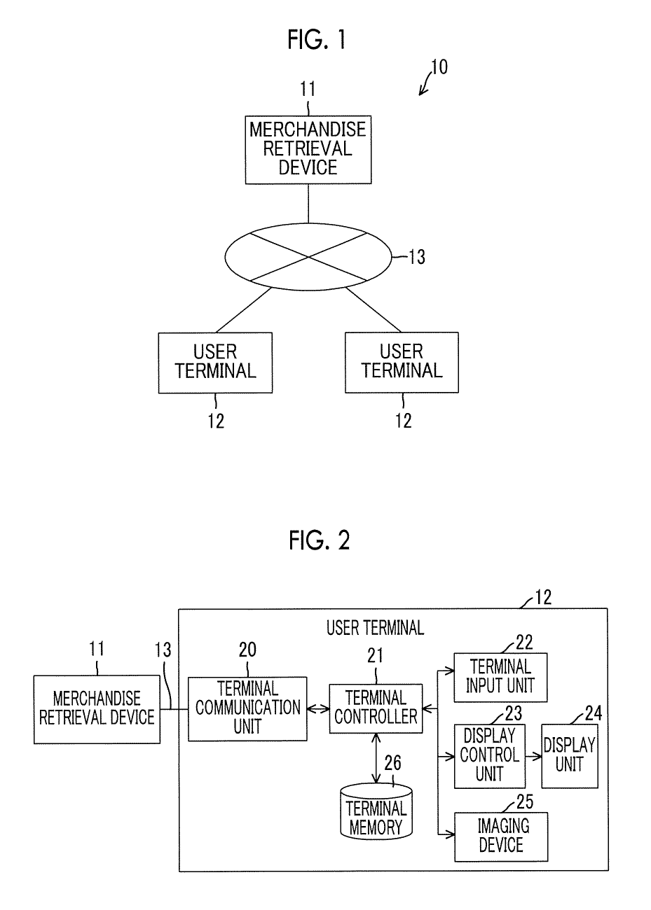

FIG. 1 is a conceptual diagram of a merchandise retrieval system 10. The merchandise retrieval system 10 according to the present embodiment includes user terminals 12, and a merchandise retrieval device (server device) 11 connected to the user terminals 12 via a network 13 such as the Internet.

For example, the user terminal 12 is a terminal operated when a user retrieves merchandise such as clothes, and may take a form such as a portable terminal such as a tablet device and a personal computer.

The merchandise retrieval device 11 together with each user terminal 12 establishes a client server model, retrieves merchandise according to an instruction sent from the user terminal 12 via the network 13, and returns the retrieval result to the user terminal 12 via the network 13.

In the merchandise retrieval system 10, a functional configuration of the user terminal 12 will be initially described.

FIG. 2 is a block diagram showing a functional configuration example of the user terminal 12.

The user terminal 12 of the present example includes a terminal communication unit 20, a terminal controller 21, a terminal input unit 22, a display control unit 23, a display unit 24, an imaging device 25, and a terminal memory 26.

Under the control of the terminal controller 21, the terminal communication unit 20 transmits and receives data to and from the merchandise retrieval device 11 via the network 13, transmits the data received from the terminal controller 21 to the merchandise retrieval device 11, and transmits the data received from the merchandise retrieval device 11 to the terminal controller 21.

The terminal input unit 22 is a part directly operated by the user for inputting the data, and transmits data including a command input in response to a user operation to the terminal controller 21. The terminal input unit 22 may be typically constituted by various devices such as a mouse or a keyboard, but is not particularly limited. The terminal input unit may be constituted by hardware and/or software. For example, in a case where the user terminal 12 is a portable terminal such as a smartphone or a tablet terminal, the terminal input unit 22 may include software keys using a touch panel, the terminal input unit 22 may include hardware keys such as buttons provided at the user terminal 12, or the terminal input unit 22 may include combinations of the software keys and the hardware keys.

For example, in a case where the terminal input unit 22 is constituted by a touch panel integrally provided with the display unit 24 (liquid crystal display) of the user terminal 12, the user may operate the terminal input unit 22 by touching a transparent touch panel on the display unit 24. The terminal controller 21 may recognize inputs such as selection and designation of various processes performed by the user based on an operation signal sent from the touch panel (terminal input unit 22) corresponding to a touch position or a touch operation (including, for example, a tapping operation, a double tapping operation, a swiping operation, a clicking operation, a pinching operation, and a dragging operation) on the touch panel.

The display control unit 23 is controlled by the terminal controller 21, and controls the display unit 24 to control overall display on the display unit 24. For example, information regarding each piece of merchandise or a retrieval result of a merchandise image sent from the merchandise retrieval device 11 to the user terminal 12 (terminal communication unit 20), an image imaged by the imaging device 25, various information items or images stored in the terminal memory 26, or data input by the user through the terminal input unit 22 may be displayed on the display unit 24 under the control of the display control unit 23. In the present example, the terminal controller 21 or the display control unit 23 is constituted by one CPU or a plurality of central processing units (CPUs). The CPU executes various programs recorded in the terminal memory 26 constituted by a hard disc drive (HDD) or a solid state drive (SSD), and thus, the user terminal is operated.

The imaging device 25 includes an optical system (imaging lens and diaphragm) and an imaging element, may image an image of an arbitrary subject under the control of the terminal controller 21, and may appropriately use the above-described terminal input unit 22 as a shutter button of the imaging device 25. The image imaged by the imaging device 25 is sent to the terminal controller 21, and is transmitted as data to the merchandise retrieval device 11 through the terminal communication unit 20, is displayed on the display unit 24 through the display control unit 23, or is stored in the terminal memory 26. The images imaged by the imaging device 25 may be used as a “retrieval condition image”, to be described below, which are used as a basic image of a retrieval process of the merchandise image of the merchandise retrieval device 11.

The terminal memory 26 stores various data items, and a read process and a write process of the data from and in the terminal memory 26 are performed by the terminal controller 21. For example, the terminal controller 21 may store and may read control programs of various devices such as the terminal controller 21, data sent from the merchandise retrieval device 11, and data sent from various devices such as the imaging device 25 constituting the user terminal 12 in the terminal memory 26 and from the terminal memory 26. The terminal memory 26 may be constituted by a single storage unit or may be constituted by a plurality of storage units, and a recording method and a constituent member of the terminal memory 26 are not particularly limited.

The terminal controller 21 controls the terminal communication unit 20, the terminal input unit 22, the display control unit 23, the imaging device 25, the terminal memory 26, and other devices constituting the user terminal 12 to transmit and receive data to and from various devices constituting the user terminal 12, to transmit and receive data to and from the merchandise retrieval device 11 through the terminal communication unit 20, or to perform various processes. Particularly, the terminal controller 21 of the present example performs various processes required to retrieve the merchandise image to be described below in cooperation with the merchandise retrieval device 11 (retrieval controller 31 to be described below).

Hereinafter, a functional configuration of the merchandise retrieval device 11 will be described.

FIG. 3 is a block diagram showing a functional configuration example of the merchandise retrieval device 11.

The merchandise retrieval device 11 of the present example includes a server communication unit 30, the retrieval controller 31, a database 32, and an image analysis unit 33. Although the example in which the server communication unit 30, the retrieval controller 31, the database 32, and the image analysis unit 33 are integrally provided is illustrated in FIG. 3, the merchandise retrieval device 11 may be constituted by combining a plurality of servers, or the “retrieval controller 31 and the server communication unit 30” and the “database 32 and the image analysis unit 33” may be separately provided. In the present example, the retrieval controller 31 or the image analysis unit 33 is constituted by one CPU or a plurality of central processing units (CPUs). Software recorded in a storage area (not shown) is executed by the CPU, and thus, the merchandise retrieval device 11 including the retrieval controller 31 or the image analysis unit 33 is operated.

Under the control of the retrieval controller 31, the server communication unit 30 transmits and receives data to and from each user terminal 12 via the network 13, transmits the data received from the retrieval controller 31 to the user terminal 12, and transmits the data received from the user terminal 12 to the retrieval controller 31.

The database 32 constituted by the HDD associates a plurality of merchandise images with metadata items (tag information items) including feature data items indicating design features of the plurality of merchandise images, and stores the associated information items.

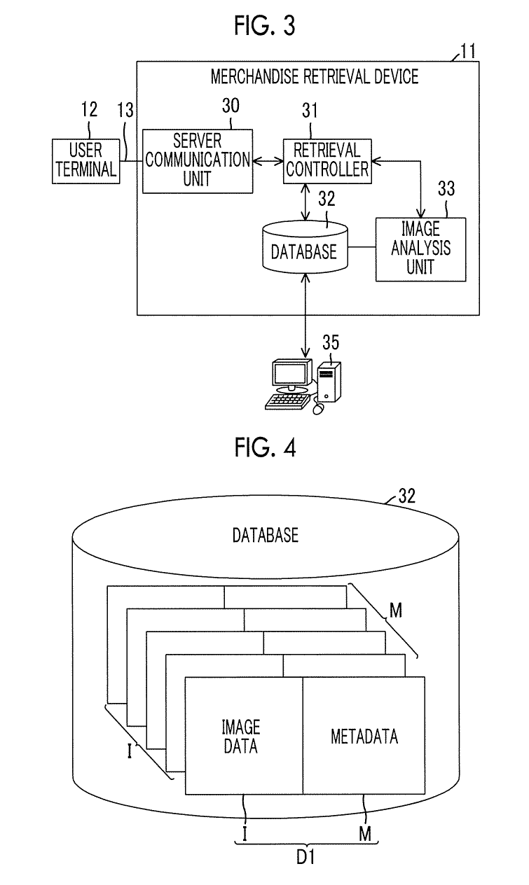

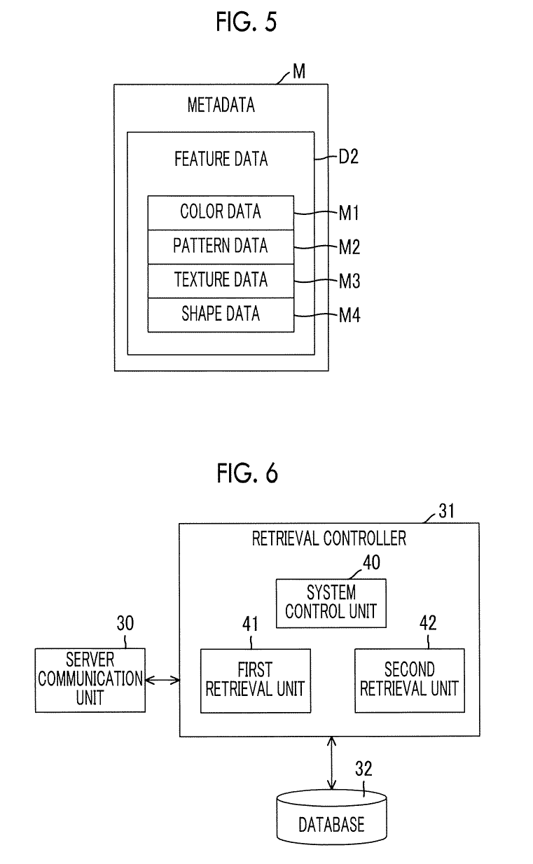

FIG. 4 is a conceptual diagram of a data structure showing a correspondence between image data I and metadata M stored in the database 32. FIG. 5 is a conceptual diagram of a data structure showing a configuration data example of the metadata M.

The metadata M including feature data D2 indicating a design feature of the merchandise is assigned to the image data I of the merchandise stored in the database 32. Image information data D1 acquired by associating the metadata M with the image data I of the merchandise is stored in the database 32.

The image data I of the merchandise is acquired by imaging the merchandise. The feature data D2 of the merchandise included in the metadata M associated with the image data I of the merchandise is acquired by analyzing the image data I of the merchandise.

That is, the feature data D2 indicating the design feature of the merchandise and characteristic data indicating characteristics of the merchandise are included in the metadata M. The design feature of the merchandise is a feature regarding one design element or a plurality of design elements, and for example, the feature data D2 may be determined by the feature regarding the design element based on at least any one of color, pattern, shape, or texture. Color data M1 of the merchandise, pattern data M2 of the merchandise, texture data M3 of the merchandise, and shape data M4 of the merchandise capable of being acquired by analyzing the image data I of the merchandise are included in the feature data D2 of the present example. The color data M1 is able to be specified based on, for example, RGB (red, green, and blue), the pattern data M2 is able to be specified based on, for example, pattern density and pattern size, and the texture data M3 is able to be specified based on, for example, glossiness and transparency. The shape data M4 is able to be specified based on, for example, the entire width (narrow-wide), a sleeve length (short-long), the entire length (short-long), a width and a height of a neckline, a sectional area (small-large) of a space through which the head of the user defined by the neckline passes, an angle (narrow-wide) of a V-shaped neck, and curvature (small-large) of a U-shaped neck.

The design element of the feature data D2 is not limited to the color, pattern, shape and texture, and the feature data D2 may be determined based on an index for further subdividing these elements or another element. Accordingly, the color data M1 may be determined based on, for example, one element or a plurality of elements of hue, saturation, and lightness which are three attributes of color. The characteristic data included in the metadata M is not particularly limited, and information data capable of being determined by a method other than the analysis of the image data I may be included in the metadata M. For example, various data items such as the price, size, and original source of the merchandise may be included in the metadata M. The feature data may be determined using combinations of color categories as an example of the design element by referring to “The COLORING BOOK COLOR DICTIONARY” (Kawade Shobo Shinsha, ISBN: 978-4-309-26181-2) or “COLOR COORDINATION” (Kawade Shobo Shinsha, ISBN: 4-309-26067-5).

The feature data D2 is able to be acquired by an arbitrary method, but the feature data D2 is acquired by the image analysis unit 33 (see FIG. 3) that analyzes the plurality of merchandise images. That is, the image analysis unit 33 acquires the feature data D2 by analyzing the image data I, adds the acquired feature data D2 to the metadata M, and stores the image data I and the metadata M in the database 32 with the image data and the metadata associated with each other. The acquisition method of the image data I as a target of the analysis performed by the image analysis unit 33 is not particularly limited. For example, the image analysis unit 33 may acquire the image data I as the analysis target by reading the image information data D1 (image data I) stored in the database 32, or may acquire the image data I of the analysis target from the outside via the network 13. As the feature acquired by the image analysis unit 33, known features such as brightness features such as brightness distributions, various wavelet features, Haar-like features, Joint Haar-like features, Edgelet features, EOH features, and HOG features may be used. It is possible to discriminate the feature added to the metadata M by using a relevant feature and a discriminator established by a machine learning method such as Adaboost.

As shown in FIG. 3, an external terminal device 35 is connected to the database 32 of the present example via the network 13, and the image information data D1 (image data I and metadata M) stored in the database 32 is able to be corrected through the external terminal device 35. For example, even in a case where the result of the image analysis performed by the image analysis unit 33 is defective and the feature data D2 included in the metadata M of the image information data D1 stored in the database 32 is inappropriate, the user (person) may correct the metadata M (feature data D2) through the external terminal device 35. Accordingly, at least some of the plurality of merchandise images can be stored in the database 32 in association with the corrected metadata M through the external terminal device 35, and appropriate metadata M (feature data D2) can be stored in the database 32 in association with the image data I even though the result of the analysis process performed by the image analysis unit 33 is inaccurate. The external terminal device 35 may be provided separately from the image analysis unit 33, or a single device may function as the external terminal device 35 and the image analysis unit 33.

The retrieval controller 31 controls the server communication unit 30, the database 32, the image analysis unit 33, and other devices constituting the merchandise retrieval device 11, and particularly performs a retrieval process of the merchandise image in cooperation with the user terminal 12 (terminal controller 21) in the present example.

FIG. 6 is a block diagram showing a functional configuration example of the retrieval controller 31. The retrieval controller 31 of the present example includes a system control unit 40, a first retrieval unit 41, and a second retrieval unit 42.

The system control unit 40 controls the overall process other than the retrieval process performed by the first retrieval unit 41 and the second retrieval unit 42, and performs, for example, a process of performing data communication with the user terminal 12 through the server communication unit 30 and the network 13 or a process of storing data and reading data in and from the database 32.

The first retrieval unit 41 and the second retrieval unit 42 constitute a retrieval process unit of the merchandise retrieval device 11, and the results of the retrieval processes of the merchandise image performed by the first retrieval unit 41 and the second retrieval unit 42 are transmitted to the user terminal 12 through the server communication unit 30 and the network 13.

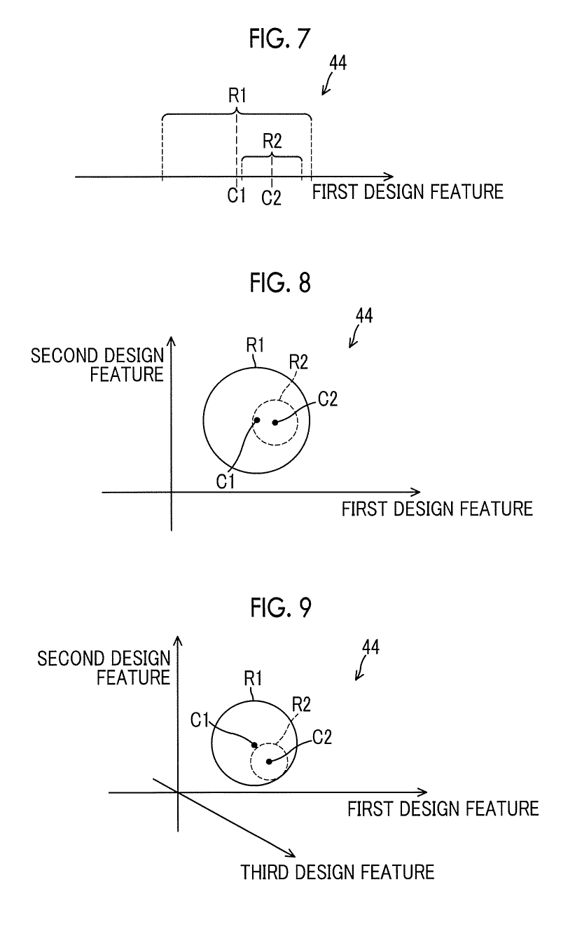

The first retrieval unit 41 analyzes the retrieval condition image (see FIG. 15 to be described below) to acquire first retrieval condition data indicating a design feature of the retrieval condition image, and retrieves a plurality of first retrieval images from the plurality of merchandise images (image data items I) stored in the database 32 based on the first retrieval condition data. More specifically, the first retrieval unit 41 refers to the image information data items D1 regarding the plurality of pieces of merchandise stored in the database 32, and specifies the image data I of the merchandise of which the feature data D2 of the metadata M is included in “a retrieval range (see FIGS. 7 to 9 (particularly, first retrieval range R1) to be described below) determined based on the first retrieval condition data”, as the first retrieval images.

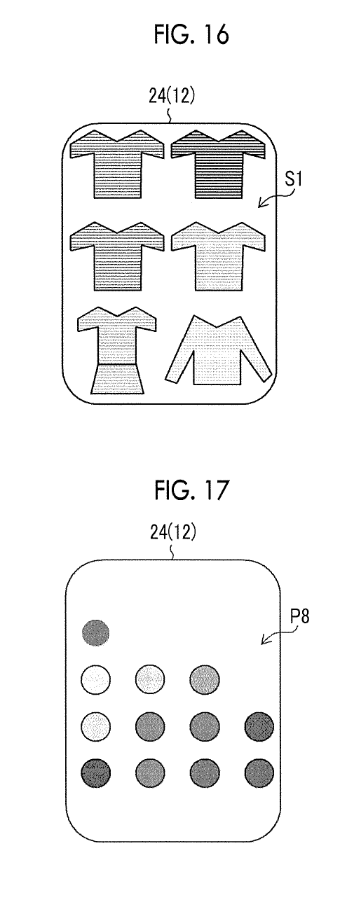

Data items of the plurality of first retrieval images specified through the retrieval process of the first retrieval unit 41 are transmitted to the user terminal 12 through the server communication unit 30 and the network 13, and the first retrieval images are displayed on the display unit 24 of the user terminal 12 (see FIG. 16 to be described below).

The retrieval condition image analyzed by the first retrieval unit 41 is data provided to the first retrieval unit 41 (merchandise retrieval device 11) from the user terminal 12 via the network 13, and is an image designated by the user in order to specify a retrieval key of the first retrieval process performed by the first retrieval unit 41. The acquisition method of the retrieval condition image is not particularly limited. For example, the user may operate the user terminal 12, and may transmit the image stored in the terminal memory 26 of the user terminal 12 to the merchandise retrieval device 11 (first retrieval unit 41), as the retrieval condition image. Alternatively, the image imaged by the imaging device 25 of the user terminal 12 may be transmitted to the merchandise retrieval device 11 (first retrieval unit 41), as the retrieval condition image.

The analysis method of the retrieval condition image is not particularly limited. For example, the first retrieval unit 41 (merchandise retrieval device 11) may specify a portion appropriate as the analysis target from the retrieval condition image, or the user may specify a portion to be used as the analysis target from the retrieval condition image, as a region of interest (ROI), through the user terminal 12 (see FIG. 15 (particularly, ROI designation portion P7) to be described below). Here, in both the above-described cases, the first retrieval condition data as the retrieval key of the retrieval process performed by the first retrieval unit 41 is automatically acquired through the image analysis performed by the first retrieval unit 41 without manual correction performed by the user.

Meanwhile, the second retrieval unit 42 shown in FIG. 6 retrieves second retrieval images from the plurality of first retrieval images based on second retrieval condition data designated as being related to the design features of the merchandise through the user terminal 12. More specifically, the second retrieval unit 42 refers to the image information data items D1 regarding the plurality of pieces of merchandise stored in the database 32, and specifies the image data I of the merchandise of which the feature data D2 of the metadata M is included in “a retrieval range (see FIGS. 7 to 9 (particularly, second retrieval range R2) to be described below) determined based on the second retrieval condition data”, as the second retrieval images. The number of second retrieval images found through the second retrieval process performed by the second retrieval unit 42 may be one or may be plural.

The second retrieval condition data is preferably related to the design feature based on the same design elements as those of the first retrieval condition data which are the retrieval key of the retrieval process of the first retrieval unit 41, and preferably includes at least some of the design elements which are bases of the design feature of the first retrieval condition data. The second retrieval condition data is related to the design elements common to the first retrieval condition data, and is included in the “retrieval range (see FIGS. 7 to 9 (particularly, first retrieval range R1)) determined based on the first retrieval condition data” by the first retrieval unit 41.

Data items of the second retrieval images specified by the retrieval process of the second retrieval unit 42 are transmitted to the user terminal 12 through the server communication unit 30 and the network 13, and the second retrieval images are displayed on the display unit 24 of the user terminal 12.

The design feature as the basis of the retrieval process in the first retrieval unit 41 and the second retrieval unit 42 is a feature regarding at least one design element, and may be a feature regarding one design element, or may be a feature regarding the plurality of design elements. For example, the design elements constituting the basis of the design element are preferably based on at least any one of the color, pattern, shape, or texture of the merchandise of the merchandise image. Accordingly, the first retrieval unit 41 and the second retrieval unit 42 may retrieve the first retrieval images and the second retrieval images by using only the “color” of the merchandise as the retrieval key, or may retrieve the first retrieval image and the second retrieval image by using the combination of the “color” and the “pattern” of the merchandise as the retrieval key.

In the present example, the first retrieval unit 41 and the second retrieval unit 42 retrieve the images through similarity evaluation, and the retrieval range using the first retrieval unit 41 is more widely set than the retrieval range using the second retrieval unit 42. That is, the first retrieval unit 41 retrieves the images having the design feature, which are included in the first retrieval range determined using the first retrieval condition data as a criterion in a feature space representing the design feature, from the plurality of merchandise images, as the first retrieval images. The second retrieval unit 42 retrieves the images having the design feature, which are included in the second retrieval range determined using the second retrieval condition data as a criterion in the feature space representing the design feature, from the plurality of first retrieval images, as the second retrieval images. The first retrieval range of the first retrieval unit 41 is more widely set than the second retrieval range of the second retrieval unit 42.

FIG. 7 is a diagram showing the relationship between the retrieval range using the first retrieval unit 41 and the retrieval range using the second retrieval unit 42 in order to show a one-dimensional feature space 44 represented by the design feature (a first design feature) based on a single design element. The “first design feature” mentioned herein is not particularly limited, and the example show in FIG. 7 may be applied to a case where the retrieval processes of the first retrieval unit 41 and the second retrieval unit 42 are performed using, for example, only the “color”, only the “pattern”, only the “shape”, or only the “texture” of the merchandise.

In the present example, the first retrieval range R1 which is the retrieval range using the first retrieval unit 41 is a range determined using first retrieval condition data C1 as a criterion. Thus, the first retrieval unit 41 performs similarity retrieval for retrieving the images having the first design feature (for example, feature such as “color”) included in the first retrieval range R1 including the first retrieval condition data C1 in addition to the first retrieval condition data C1 determined by the retrieval condition image, as the first retrieval images.

For example, in a case where the first retrieval condition data is specified by a color palette number for defining color, the first retrieval unit 41 analyzes the retrieval condition image to specify the color palette number indicating color of the retrieval condition image. The first retrieval unit 41 specifies a color palette number positioned within a predetermined neighboring distance from a “color palette number of color of the retrieval condition image” in the feature space 44 based on a color space, as a neighboring color palette number. That is, the first retrieval unit 41 determines the first retrieval range R1 determined by using the first retrieval condition data C1 as the “color palette number of the color of the retrieval condition image”, and specifies the color palette number included in the first retrieval range R1, as the neighboring color palette number. The first retrieval unit 41 refers to the color data M1 of the metadata M of the image information data D1 stored in the database 32, and selects the images (image data items I) equivalent to the color palette number (neighboring color palette number) included in the first retrieval range R1, as the first retrieval images.

The first retrieval range R1 of the present example can be more widely set than the second retrieval range R2 of the second retrieval unit 42, and desired merchandise images can be effectively included in the plurality of first retrieval images even though there is an error in the first retrieval condition data C1 acquired by analyzing the retrieval condition image. Accordingly, the first retrieval range R1 may be determined depending on analysis accuracy of the retrieval condition image, or the first retrieval unit 41 may determine the first retrieval range R1 depending on an acquisition condition or a state of the retrieval condition image.

Meanwhile, the second retrieval range R2 which is the retrieval range of the second retrieval unit 42 is a range determined using the second retrieval condition data C2 as the criterion. The second retrieval unit 42 performs similarity retrieval for retrieving the images having the first design feature (for example, feature such as “color”) included in the second retrieval range R2 including the second retrieval condition data C2 in addition to the second retrieval condition data C2 designated by the user through the user terminal 12, as the second retrieval images. The second retrieval range R2 of the second retrieval unit 42 is included in the first retrieval range R1 of the first retrieval unit 41, and is more narrowly set than the first retrieval range R1. The second retrieval range R2 which is the retrieval range of the second retrieval unit 42 is more narrowly set than the first retrieval range R1 which is the retrieval range of the first retrieval unit 41 in this manner, and thus, the merchandise images can be more efficiently narrowed down through the retrieval process performed by the second retrieval unit 42.

The specific ranges of the first retrieval range R1 and the second retrieval range R2 are not particularly limited. In the feature space 44, a threshold of the similarity evaluation for determining a boundary of the first retrieval range R1 and a distance from the first retrieval condition data C1 are preferably smaller than a threshold for determining a boundary of the second retrieval range R2 and a distance from the second retrieval condition data C2. For example, in order to more efficiently narrow down the merchandise images, the second retrieval range R2 is preferably equal to or less than 50% of the first retrieval range R1, more preferably, equal to or less than 30%, and is still more preferably equal to or less than 10%. In order to reduce the number of merchandise images retrieved through the retrieval process of the second retrieval unit 42, it is preferable that the second retrieval range R2 includes only the first design feature equivalent to the second retrieval condition data C2 and the second retrieval unit 42 selects only the merchandise images equivalent to the second retrieval condition data C2, as the second retrieval images.

As stated above, the retrieval process of the present example includes the first retrieval process performed by the first retrieval unit 41 and the second retrieval process performed by the second retrieval unit 42. The first retrieval process is performed based on the “first retrieval condition data acquired by analyzing the retrieval condition image”, and the second retrieval process is performed based on the “second retrieval condition data designated by the user through the user terminal 12”. Thus, the user can retrieve desired merchandise images intuitively and conveniently through the first retrieval process using the retrieval condition image. The user can more accuracy specify desired merchandise images by efficiently more narrowing down the merchandise images as the targets through the second retrieval process using the second retrieval condition data designated through the user terminal 12. The above-described first retrieval process and second retrieval process are simultaneously used in this manner, and thus, it is possible to accurately find images of merchandise expected by the user through the second retrieval process even in a case where the first retrieval condition data is not able to be determined with high accuracy from the retrieval condition image in the first retrieval process. Particularly, in a case where retrieval accuracy of the first retrieval unit 41 is not high, the first retrieval range R1 is set to be comparatively wide, and the number of retrieved images using the first retrieval unit 41 is large. Thus, it is possible to retrieve desired merchandise images expected by the user accurately and conveniently through the retrieval process using the second retrieval unit 42.

FIG. 7 shows an example in which the design feature considered in the retrieval processes of the first retrieval unit 41 and the second retrieval unit 42 is a feature (see “first design feature” of FIG. 7) regarding one design element, but the design feature considered in the retrieval processes of the first retrieval unit 41 and the second retrieval unit 42 may be features regarding the plurality of design elements, or may be a feature regarding the design element based on, for example, at least one of the color, pattern, shape, or texture.

FIG. 8 is another diagram showing the relationship between the retrieval range using the first retrieval unit 41 and the retrieval range using the second retrieval unit 42 in order to show the two-dimensional feature space 44 represented by the design features (a first design feature and a second design feature) based on two types of design elements. FIG. 9 is still another diagram showing the relationship between the retrieval range using the first retrieval unit 41 and the retrieval range using the second retrieval unit 42 in order to a three-dimensional feature space 44 represented by the design features (a first design feature, a second design feature, and a third design feature) based on three types of design elements.

In the examples shown in FIGS. 8 and 9, the first retrieval range R1 which is the retrieval range using the first retrieval unit 41 is smaller than the second retrieval range R2 which is the retrieval range using the second retrieval unit 42, and thus, it is possible to perform the “first retrieval process capable of effectively finding the plurality of first retrieval images including desired merchandise images through a high-convenient and intuitive retrieval process” while it is possible to perform the “high-retrieval-accuracy second retrieval process” for complementing the first retrieval process.

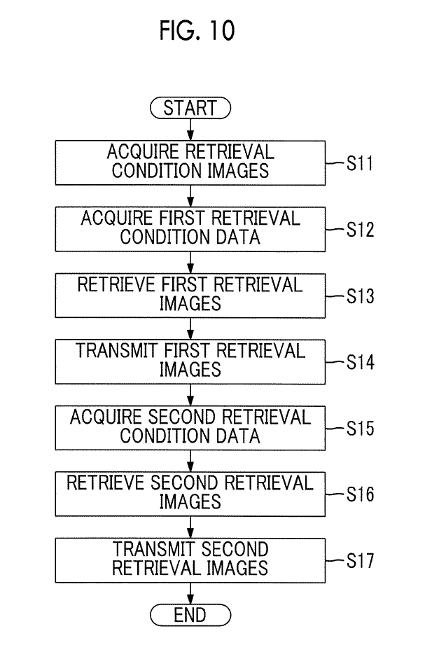

Hereinafter, a retrieval process flow in the merchandise retrieval device 11 will be described with reference to FIG. 10.

FIG. 10 is a flowchart showing an example of a processing flow of the merchandise retrieval method performed by the merchandise retrieval device 11.

In the merchandise retrieval device 11, the data of the retrieval condition image transmitted from the user terminal 12 via the network 13 is initially received by the server communication unit 30, and the data of the retrieval condition image is acquired by the first retrieval unit 41 (retrieval controller 31) (step S11 of FIG. 10).

The retrieval condition image is analyzed by the first retrieval unit 41, and the first retrieval condition data indicating the design feature of the retrieval condition image is acquired (S12). The plurality of first retrieval images is retrieved from the plurality of merchandise images stored in the database 32 based on the first retrieval condition data (S13).

The data items of the plurality of first retrieval images retrieved in this manner are transmitted to the user terminal 12 from the first retrieval unit 41 (retrieval controller 31) through the server communication unit 30 (S14), and the first retrieval process is completed.

Thereafter, in the merchandise retrieval device 11, the second retrieval condition data designated as being related to the design feature through the user terminal 12 is received by the server communication unit 30, and the second retrieval condition data is acquired by the second retrieval unit 42 (retrieval controller 31) (S15). The second retrieval images are retrieved by the second retrieval unit 42 from the plurality of first retrieval images based on the second retrieval condition data (S16). The data items of the second retrieval images retrieved in this manner are transmitted to the user terminal 12 from the second retrieval unit 42 (retrieval controller 31) through the server communication unit 30 (S17), and the second retrieval process is completed.

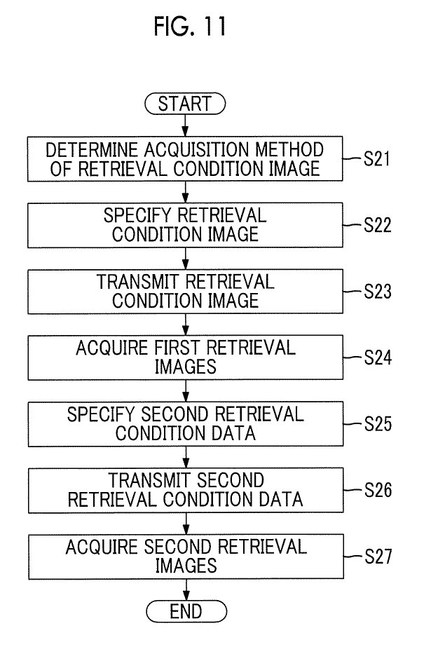

Hereinafter, a retrieval process flow in the user terminal 12 will be described with reference to FIGS. 11 to 18.

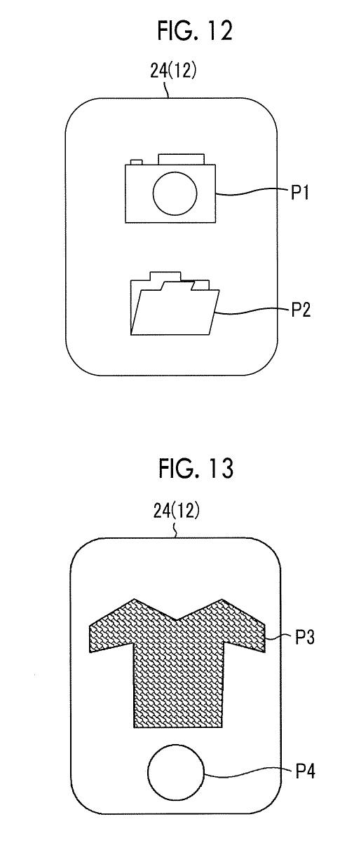

FIG. 11 is a flowchart showing an example of a processing flow in the user terminal 12 when the retrieval process of the merchandise image is performed. FIGS. 12 to 18 are diagrams showing display examples in the display unit 24 of the user terminal 12 when the retrieval process of the merchandise image is performed.

Hereinafter, for the sake of convenience, an example in which the first retrieval condition data and the second retrieval condition data are based on the design feature of “color” will be described. Particularly, an example in which the first retrieval condition data and the second retrieval condition data are based on the color palette number determined depending on the kind of the color will be described. The following example may be applied to a case where the first retrieval condition data and the second retrieval condition data are determined based on the design feature other than color, and may be applied to a case where the first retrieval condition data and the second retrieval condition data are determined based on the design features regarding the plurality of design elements.

In the user terminal 12, the acquisition method of the retrieval condition image is determined (step S21 of FIG. 11). In the present example, there are a mode (hereinafter, referred to as an “imaging mode”) in which the retrieval condition image is imaged by the imaging device 25 and a mode (hereinafter, referred to as an “image reading mode”) in which the retrieval condition image is selected from the images stored in the user terminal 12 (terminal memory 26), the user of the user terminal 12 may select any one of an imaging mode and an image reading mode.

In the example shown in FIG. 12, an imaging mode designation portion P1 which is an icon indicating the imaging mode and an image reading mode designation portion P2 which is an icon indicating the image reading mode are displayed on the display unit 24 of the user terminal 12. Any one of the imaging mode designation portion P1 and the image reading mode designation portion P2 is designated by operating the terminal input unit 22, and thus, the user can select a desired mode of the imaging mode and the image reading mode. Information of the mode selected by the user is specified by the terminal controller 21 in response to an operation signal from the terminal input unit 22, and the terminal controller 21 determines the mode selected by the user as the acquisition method of the retrieval condition image.

If the acquisition method of the retrieval condition image is determined, the retrieval condition images are specified in the user terminal 12 (S22).

For example, in a case where the imaging mode is selected, the terminal controller 21 controls the imaging device 25 and the display control unit 23 to transition to the imaging mode, and prompts the imaging device and the display control unit to image the retrieval condition image. A display aspect of the display unit 24 of the user terminal 12 in the imaging mode is not particularly limited, and for example, the display control unit 23 may display a live-view image P3 or an operation instruction image P4 such as a shutter instruction portion on the display unit 24, as shown in FIG. 13. For example, the user images a clothes image published in a magazine by using the user terminal 12 (imaging device 25), and thus, the user can conveniently specify the retrieval condition image. The data of the image imaged by the imaging device 25 in the imaging mode may be stored in the terminal memory 26 by the terminal controller 21, or may be temporarily stored and retained in a memory (not shown) within the terminal controller 21 without being stored in the terminal memory 26.

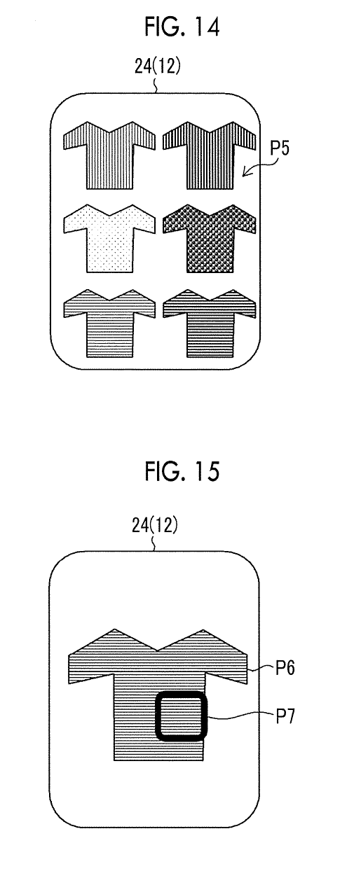

Meanwhile, in a case where the image reading mode is selected, the terminal controller 21 controls the terminal memory 26 and the display control unit 23 to transition to the image reading mode, and prompts the user to select the retrieval condition image from the images stored in the terminal memory 26. A display aspect of the display unit 24 of the user terminal 12 in the image reading mode is not particularly limited, and for example, the display control unit 23 may display stored images P5 stored in the terminal memory 26 on the display unit 24, as shown in FIG. 14. A list of a plurality (six) of stored images P5 is displayed on the display unit 24 in the example shown in FIG. 14, but a single stored image P5 may be displayed on the display unit 24 or another information together with the stored images P5 may be displayed on the display unit 24. The user designates an arbitrary image from the stored images P5 displayed on the display unit 24 through the terminal input unit 22, and thus, the retrieval condition image can be conveniently specified.

The data items of the retrieval condition image specified in this manner is transmitted to the merchandise retrieval device 11 from the terminal controller 21 through the terminal communication unit 20 (S23), and the first retrieval process of the merchandise retrieval device 11 (first retrieval unit 41) is used. As mentioned above, the first retrieval condition data as the retrieval key of the first retrieval process is acquired by analyzing the retrieval condition image, but a specific analysis portion of the retrieval condition image may be determined by the merchandise retrieval device 11 (first retrieval unit 41), or may be determined by the user through the user terminal 12. For example, in a case where the analysis target of the retrieval condition image is determined by the merchandise retrieval device 11 (first retrieval unit 41), the first retrieval unit 41 may determine a portion appropriate for the analysis target from the retrieval condition image based on an arbitrary analysis method, and may acquire the first retrieval condition data by analyzing the specified portion.

Meanwhile, in a case where the analysis portion of the retrieval condition image is determined by the user through the user terminal 12, the user terminal 12 may display an image on the display unit 24 as shown in, for example, FIG. 15, and may prompt the user to designate a specific analysis portion of the retrieval condition image. That is, the terminal controller 21 controls the display control unit 23 to display a retrieval condition image P6 and the ROI designation portion P7 on the display unit 24. The user adjusts a position of the ROI designation unit P7 through the terminal input unit 22, and thus, a region (ROI) indicating the retrieved design feature is designated from the retrieval condition image P6. A shape or a size of the ROI designation portion P7 is not particularly limited, and for example, the terminal controller 21 may change the shape or the size of the ROI designation portion P7 on the display unit 24 in response to the operation (for example, the pinching operation on the touch panel) of the user who uses the terminal input unit 22. The terminal controller 21 may determine the region (ROI) specified by the ROI designation portion P7 of which the position is adjusted by the user, as the analysis portion. As stated above, data of the analysis portion (retrieval condition image) determined in the user terminal 12 is transmitted to the merchandise retrieval device 11 from the terminal controller 21 through the terminal communication unit 20, and is used in the first retrieval process of the merchandise retrieval device 11 (first retrieval unit 41).

The data items of the plurality of first retrieval images retrieved through the first retrieval process are transmitted to the user terminal 12 from the merchandise retrieval device 11 (first retrieval unit 41) via the network 13, and are acquired by the terminal controller 21 through the terminal communication unit 20 (S24). For example, the terminal controller 21 controls the display control unit 23 to display first retrieval images S1 on the display unit 24 as shown in FIG. 16, and the result images of the first retrieval process are presented to the user of the user terminal 12.

The terminal controller 21 transitions to a designation mode of the second retrieval condition data. That is, for example, the terminal controller 21 (user terminal 12) controls the display control unit 23 to display a color palette designation portion P8 as a plurality of candidates regarding the design feature on the display unit 24 as shown in FIG. 17, and some of the color palette designation portion P8 which is the plurality of candidates are presented by the terminal input unit 22 so as to be designated by the user. The user designates the color palette indicating color as the retrieval key of a narrowing retrieval process from the color palette designation portion P8 as the plurality of presented candidates through the terminal input unit 22. The terminal controller 21 specifies the color palette designated by the user from the color palette designation portion P8 as the plurality of candidates based on an input signal from the terminal input unit 22, and specifies the color palette number as the second retrieval condition data (S25).

In a case where some of the plurality of candidates are presented to the user so as to be designated, like the color palette designation portion P8 shown in FIG. 17, when the second retrieval condition data is determined, the terminal controller 21 preferably determines the plurality of specific candidates (for example, color palette designation portion P8) presented to the user based on the design features of the plurality of first retrieval images retrieved by the first retrieval unit 41. That is, the terminal controller 21 preferably determines the plurality of candidates presented to the user when the second retrieval condition data is determined, from the design features of the plurality of first retrieval images.

The second retrieval condition data specified in this manner is transmitted to the merchandise retrieval device 11 from the terminal controller 21 through the terminal communication unit 20 (S26), and is used in the second retrieval process of the merchandise retrieval device 11 (second retrieval unit 42). That is, the second retrieval unit 42 determines the second retrieval condition data based on the color palette number which is the design feature of the color palette designated by the user from the color palette designation portion P8 as the plurality of candidates. The second retrieval unit 42 performs the second retrieval process based on the determined second retrieval condition data, and retrieves the second retrieval image.

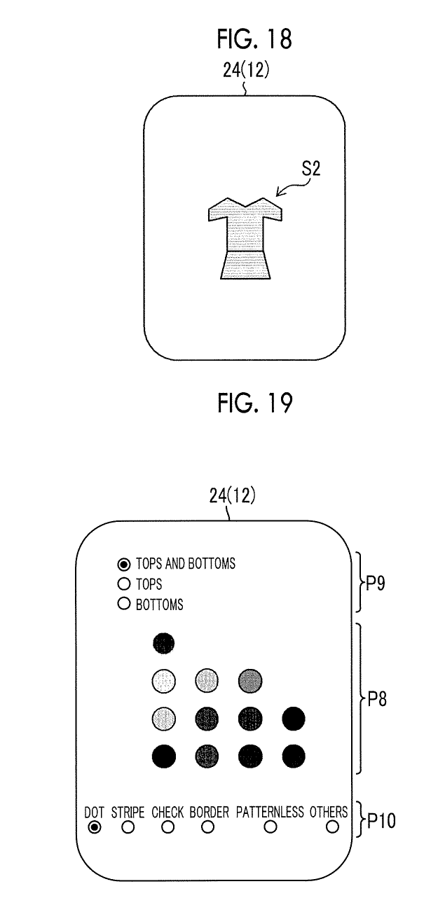

The data of the second retrieval image retrieved through the second retrieval process is transmitted to the user terminal 12 from the merchandise retrieval device 11 (second retrieval unit 42) via the network 13, and is acquired by the terminal controller 21 through the terminal communication unit 20 (S27). For example, the terminal controller 21 controls the display control unit 23 to display a second retrieval image S2 on the display unit 24 as shown in FIG. 18, and presents the result image of the second retrieval process to the user of the user terminal 12.

As described above, according to a series of retrieval processes of the present example, the first retrieval process using the image (retrieval condition image) as the retrieval key and the second retrieval process using the design feature as the retrieval key are combined, and thus, it is possible to effectively improve the findability of the merchandise retrieval.

In the above-described example, the retrieval processes of the first retrieval unit 41 and the second retrieval unit 42 are performed using color (particularly, color palette number) as the design feature, but the first retrieval unit 41 and the second retrieval unit 42 may use the design feature as the retrieval keys (first retrieval condition data and second retrieval condition data) based on another design element, or may use the design feature as the retrieval key based on the plurality of design elements. The second retrieval condition data may be data indicating the design feature based on the same design element as that of the first retrieval condition data, or may include data indicating another retrieval condition in addition to the design feature indicated by the first retrieval condition data.

For example, in a mode in which the user designates the second retrieval condition data by using the user terminal 12 (see FIG. 17), the terminal controller 21 may control the display control unit 23 to display a merchandise category designation portion P9 or a pattern attribute designation portion P10 on the display unit 24 in addition to the color palette designation portion P8, as shown in FIG. 19. In this case, the user may select a desired merchandise category from the merchandise categories (“tops and bottoms”, “tops”, and “bottoms” in the example shown in FIG. 19) represented by the merchandise category designation portion P9 and may select a desired pattern attribute from the pattern attributes (“dot”, “stripe”, “check”, “border”, “patternless”, and “others” in the example shown in FIG. 19) represented by the pattern attribute designation portion P10 through the terminal input unit 22. In the example shown in FIG. 19, the terminal controller 21 acquires information regarding the color palette, the merchandise category, and the pattern attribute selected by the user in response to the operation signal from the terminal input unit 22 to specify the second retrieval condition data, and transmits the second retrieval condition data to the merchandise retrieval device 11. The second retrieval unit 42 of the merchandise retrieval device 11 performs the retrieval process of the second retrieval image based on the “information regarding the color palette, the merchandise category, and the pattern attribute selected by the user” included in the second retrieval condition data.

The above-described functional configuration may be realized by arbitrary hardware, software, or a combination of them. For example, the present invention may be applied to a program for causing a computer to perform the processing methods (processing procedures) and controlling methods (controlling procedures) in the respective unit of the merchandise retrieval device 11 and the user terminal 12, a computer-readable recording medium (non-transitory recording medium) that records the program, or a computer in which the program is installed. Particularly, the above-described processes in the user terminal 12 may be performed on a dedicated application, or may be performed on a browser.

The form of the user terminal 12 of the present invention is not particularly limited, and includes a cellular phone, a smartphone, a personal digital assistants (PDA), and a portable game machine. Hereinafter, an example of the smartphone to which the present invention may be applied will be described.

<Configuration of Smartphone>

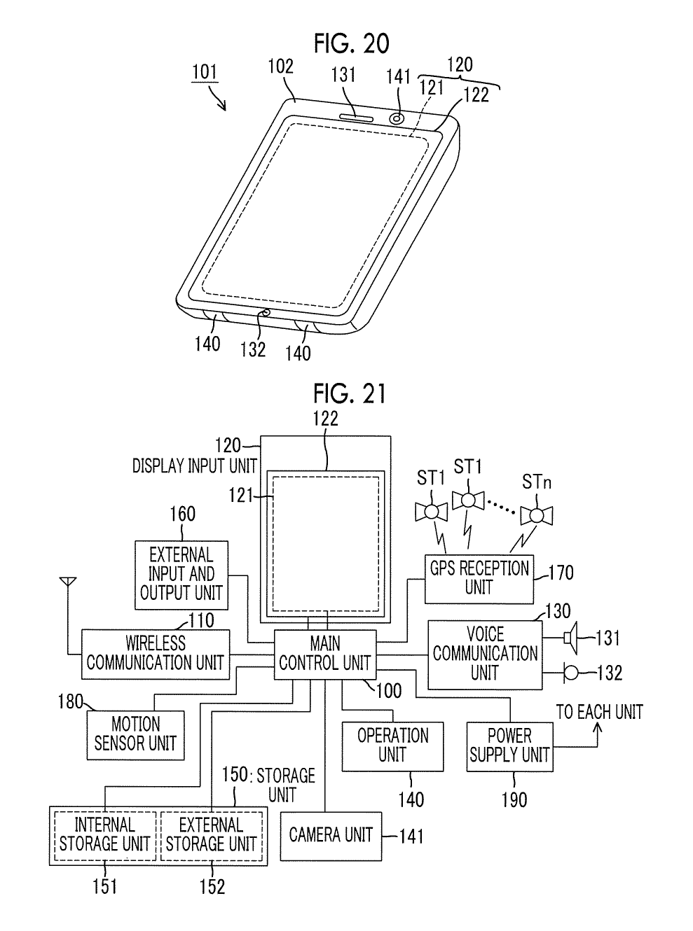

FIG. 20 is a diagram showing an external appearance of a smartphone 101. The smartphone 101 shown in FIG. 20 includes a plate-like housing 102, and includes a display input unit 120 in which a display panel 121 as a display unit and an operation panel 122 as an input unit are integrally provided on one surface of the housing 102. The housing 102 includes a speaker 131, a microphone 132, an operation unit 140, and a camera unit 141. A configuration of the housing 102 is not limited, and the housing may have a configuration in which the display unit and the input unit are independently provided, may have a folding structure, or may include a sliding mechanism.

FIG. 21 is a block diagram showing the configuration of the smartphone 101 shown in FIG. 20. As shown in FIG. 21, as main constituent elements, the smartphone includes a wireless communication unit 110, the display input unit 120, a voice communication unit 130, the operation unit 140, the camera unit 141, a storage unit 150, an external input and output unit 160, a Global Positioning System (GPS) reception unit 170, a motion sensor unit 180, a power supply unit 190, and a main control unit 100. As a main function, the smartphone 101 has a wireless communication function of performing mobile wireless communication with a base station apparatus via a mobile communication network.

The wireless communication unit 110 performs wireless communication with the base station apparatus included in the mobile communication network according to an instruction of the main control unit 100. Through the wireless communication, various file data items such as sound data and image data or electronic mail data are transmitted and received or web data or streaming data is received.

The display input unit 120 includes the display panel 121 and the operation panel 122 which are so-called touch panels that visually supply information to the user by displaying an image (still image or moving image) or character information and detect a user operation for the display information under the control of the main control unit 100.

The display panel 121 uses a liquid crystal display (LCD) or an organic electro-luminescence display (OLED) as a display device. The operation panel 122 is a device that is mounted on a display surface of the display panel 121 so as to cause the displayed image to be visually perceived and detects one or a plurality of coordinates operated by the finger of the user or a stylus. If the operation panel is operated by the finger of the user or the stylus, a detection signal generated by the operation is output to the main control unit 100. Subsequently, the main control unit 100 detects an operation position (coordinates) on the display panel 121 based on the received detection signal.

The display input unit 120 is configured such that the display panel 121 and the operation panel 122 of the smartphone 101 illustrated as the embodiment of the imaging device of the present invention are integrally provided as shown in FIG. 20, but the operation panel 122 is disposed so as to completely cover the display panel 121. In a case where the display input unit is disposed in this manner, the operation panel 122 may also have a function of detecting the user operation in a region other than the display panel 121. In other words, the operation panel 122 may include a detection region (hereinafter, referred to as a “display region”) for an overlapping portion which overlaps the display panel 121 and a detection region (hereinafter, referred to as a “non-display region”) for an outer edge portion which does not overlap with the display panel 121.

A size of the display region and a size of the display panel 121 may completely match each other, or these sizes do not necessarily match each other. The operation panel 122 may include two sensitive regions including the outer edge portion and an inner portion other than the outer edge. A width of the outer edge portion is appropriately designed depending on a size of the housing 102. As a position detection method employed by the operation panel 122, there are a matrix switch method, a resistive layer method, a surface acoustic wave method, an infrared-light method, an electromagnetic induction method, and a capacitive method. Any method may be employed.

The voice communication unit 130 includes the speaker 131 or the microphone 132, and is a unit that converts user's voice input through the microphone 132 into voice data capable of being processed by the main control unit 100 to output the converted voice data to the main control unit 100 and decodes the voice data received by the wireless communication unit 110 or the external input and output unit 160 to output the decoded voice data through the speaker 131. For example, the speaker 131 may be mounted on the same surface as the surface on which the display input unit 120 is provided as shown in FIG. 20, and the microphone 132 may be mounted on a side surface of the housing 102.

The operation unit 140 is a hardware key using a key switch, and receives an instruction from the user. For example, as shown in FIG. 20, the operation unit 140 is a push-button type switch that is mounted on a side surface of the housing 102 of the smartphone 101, is turned on if the user presses the operation unit with their finger, and is turned off due to a restoring force of a spring if the user removes their finger.

The storage unit 150 stores a control program or control data of the main control unit 100, application software, address data acquired by associating a name and a telephone number of a communication partner, data of transmitted and received electronic mails, web data downloaded through a web browser, or downloaded content data, and temporarily stores streaming data. The storage unit 150 includes an internal storage unit 151 built in the smartphone and an external storage unit 152 having an external memory slot capable of being detachably attached. The internal storage unit 151 and the external storage unit 152 constituting the storage unit 150 are realized using a storage medium such as a flash memory type, a hard disk type, a multimedia card micro type, a card type memory (for example, MicroSD (registered trademark) memory), a random access memory (RAM), or a read only memory (ROM).

The external input and output unit 160 functions as an interface of all external devices connected to the smartphone 101, and is directly or indirectly connected to another external device through communication (for example, universal serial bus (USB) or IEEE 1394) or a network (for example, the Internet, a wireless local area network (LAN), Bluetooth (registered trademark), radio frequency identification (RFID), the Infrared Data Association (IrDA) (registered trademark), Ultra-wideband (UWB) (registered trademark), or ZigBee (registered trademark)).

For example, as the external device connected to the smartphone 101, there are wired or wireless headsets, wired or wireless external chargers, wired or wireless data ports, a memory card, a subscriber identity module card (SIM), or a user identity module card (UIM) card which is connected through a card socket, external audio and video devices connected through audio and video input and output (I/O) terminals, external audio and video devices connected in a wireless manner, a smartphone connected in a wired or wireless manner, a personal computer connected in a wired or wireless manner, a PDA connected in a wired or wireless manner, or an earphone connected in a wired or wireless manner. The external input and output unit may deliver data received from such external device to the internal constituent elements of the smartphone 101 or may transmit internal data of the smartphone 101 to the external device.

According to the instruction of the main control unit 100, the GPS reception unit 170 receives GPS signals transmitted from GPS satellites ST1 to STn, performs a positioning computation process based on the plurality of received GPS signals, and detects a position from latitude, longitude, and altitude of the smartphone 101. When positional information is able to be acquired from the wireless communication unit 110 or the external input and output unit 160 (for example, wireless LAN), the GPS reception unit 170 may detect the position by using the positional information.

For example, the motion sensor unit 180 includes a tri-axial acceleration sensor, and detects a physical movement of the smartphone 101 according to the instruction of the main control unit 100. The physical movement of the smartphone 101 is detected, and thus, acceleration or a movement direction of the smartphone 101 is detected. The detection result is output to the main control unit 100.

The power supply unit 190 supplies power accumulated in a battery (not shown) to the respective units of the smartphone 101 according to the instruction of the main control unit 100.

The main control unit 100 includes a microprocessor, and is operated according to the control program or the control data stored in the storage unit 150. The main control unit generally controls the respective units of the smartphone 101. The main control unit 100 has an application processing function and a mobile communication control function of controlling the respective units of a communication system in order to perform voice communication or data communication through the wireless communication unit 110.

The main control unit 100 is operated according to the application software stored in the storage unit 150, and thus, the application processing function is realized. For example, as the application processing function, there are an infrared communication function of performing data communication with a counterpart device, an electronic mail function of transmitting and receiving electronic emails, and a web browsing function of displaying web pages by controlling the external input and output unit 160.

The main control unit 100 has an image processing function of displaying a video on the display input unit 120 based on image data (data of still image or moving image) such as the received data or downloaded streaming data. The image processing function refers to a function of the main control unit 100 that displays the image on the display input unit 120 by decoding the image data and performing image processing on the decoded result.

The main control unit 100 performs display control for the display panel 121 and operation detection control for detecting the user operation performed through the operation unit 140 and the operation panel 122.

Through the display control, the main control unit 100 displays an icon for activating the application software or a software key such as a scrollbar, or displays a window for writing the electronic mail. The scrollbar refers to a software key for receiving an instruction to move a display portion of an image for an image larger than a display region of the display panel 121.

Through the operation detection control, the main control unit 100 detects the user operation performed through the operation unit 140, receives an operation for the icon or an input of a character string in an input field of the window through the operation panel 122, or receives a scrolling request of the display image through the scrollbar.

Through the operation detection control, the main control unit 100 has a touch panel control function of determines whether an operation position for the operation panel 122 is an overlapping portion (display region) which overlaps the display panel 121 or an outer edge portion (non-display region) which does not overlap the display panel 121 and controlling a sensitive region of the operation panel 122 or a display position of the software key.

The main control unit 100 may detect a gesture operation for the operation panel 122, and may perform a preset function in response to the detected gesture operation. The gesture operation refers to not a simple touch operation of the related art but an operation of drawing a trace with the finger, simultaneously designating a plurality of positions, or drawing a trace for at least one of the plurality of positions through a combination thereof.

The camera unit 141 is a digital camera that electronically images by using an imaging element such as a complementary metal oxide semiconductor (CMOS) or a charge-coupled device (CCD). Under the control of the main control unit 100, the camera unit 141 may convert the imaged image data into image data acquired by performing compression such as the Joint Photographic Experts Group (JPEG) on the imaged image data, may record the converted image data in the storage unit 150, or may output the image data through the external input and output unit 160 or the wireless communication unit 110. Although the camera unit 141 is mounted on the same surface as that of the display input unit 120 in the smartphone 101 shown in FIG. 20, the mounting position of the camera unit 141 is not limited thereto. The camera unit may be mounted on a rear surface of the display input unit 120, or a plurality of camera units 141 may be mounted. In a case where the plurality of camera units 141 is mounted, the imaging may be performed by a single camera unit while switching between the camera units 141 to be used in the imaging or may be simultaneously performed by using the plurality of camera units 141.

The camera unit 141 may use various functions of the smartphone 101. For example, the image acquired by the camera unit 141 may be displayed on the display panel 121, or the image of the camera unit 141 may be used as one of the operation inputs of the operation panel 122. When the GPS reception unit 170 detects the position, the GPS reception unit can detect the position by referring to the image from the camera unit 141. An optical axis direction of the camera unit 141 of the smartphone 101 or a current utilization environment may be determined by referring to the image from the camera unit 141 without using the tri-axial acceleration sensor or by using the tri-axial acceleration sensor. Of course, the image from the camera unit 141 may be used within the application software.

In addition, the positional information acquired by the GPS reception unit 170, voice information (may be text information acquired by the main control unit that performs voice-to-text conversion) acquired by the microphone 132, posture information acquired by the motion sensor unit 180 may be added to the image data of the still image or the moving image, and the resultant information may be recorded in the storage unit 150 or may be output through the external input and output unit 160 or the wireless communication unit 110.

The above-described terminal communication unit 20 (see FIG. 2) is realized by, for example, the wireless communication unit 110 and the external input and output unit 160 (see FIG. 21), and the terminal controller 21 is realized by, for example, the main control unit 100. The terminal input unit 22 is realized by, for example, the operation unit 140 and the operation panel 122, and the imaging device 25 is realized by, for example, the camera unit 141. The display control unit 23 is realized by, for example, the main control unit 100, and the display unit 24 is realized by, for example, the display panel 121. The terminal memory 26 is realized by, for example, the storage unit 150 (internal storage unit 151 and external storage unit 152).

### EXPLANATION OF REFERENCES

10: merchandise retrieval system
11: merchandise retrieval device
12: user terminal
13: network
20: terminal communication unit
21: terminal controller
22: terminal input unit
23: display control unit
24: display unit
25: imaging device
26: terminal memory
30: server communication unit
31: retrieval controller
32: database
33: image analysis unit
35: external terminal device
40: system control unit
41: first retrieval unit
42: second retrieval unit
44: feature space
100: main control unit
101: smartphone
102: housing
110: wireless communication unit
120: display input unit
121: display panel
122: operation panel
130: voice communication unit
131: speaker
132: microphone
140: operation unit
141: camera unit
150: storage unit
151: internal storage unit
152: external storage unit
160: external input and output unit
170: GPS reception unit
180: motion sensor unit
190: power supply unit

What is claimed is:

1. A merchandise retrieval device that is connected to a user terminal via a network, the device comprising:
a first retrieval unit that analyzes a retrieval condition image to acquire first retrieval condition data indicating a design feature regarding at least one design element of the retrieval condition image, and automatically retrieves a plurality of first retrieval images from a plurality of merchandise images stored in a database based on the first retrieval condition data; and
a second retrieval unit that retrieves second retrieval images from the plurality of first retrieval images based on second retrieval condition data designated as being related to the design feature through the user terminal,
wherein the first retrieval unit retrieves images having the design feature, which are included in a first retrieval range determined using the first retrieval condition data as a criterion in a feature space representing the design feature, from the plurality of merchandise images, as the first retrieval images,
the second retrieval unit retrieves images having the design feature, which are included in a second retrieval range determined using the second retrieval condition data as a criterion in the feature space, from the plurality of first retrieval images, as the second retrieval images, and
the first retrieval range is larger than the second retrieval range, and the second retrieval range is included in the first retrieval range.

2. The merchandise retrieval device according to claim 1,
wherein the design element is based on at least one of color, a pattern, a shape, or texture.

3. The merchandise retrieval device according to claim 1,
wherein the second retrieval range is equal to or less than 50% of the first retrieval range.

4. The merchandise retrieval device according to claim 2,
wherein the second retrieval range is equal to or less than 50% of the first retrieval range.

5. The merchandise retrieval device according to claim 1,
wherein the second retrieval range includes only the design feature equivalent to the second retrieval condition data.

6. The merchandise retrieval device according to claim 2,
wherein the second retrieval range includes only the design feature equivalent to the second retrieval condition data.

7. The merchandise retrieval device according to claim 3,
wherein the second retrieval range includes only the design feature equivalent to the second retrieval condition data.

8. The merchandise retrieval device according claim 1,
wherein the user terminal includes an imaging device, and
the retrieval condition image is imaged by the imaging device.

9. The merchandise retrieval device according claim 2,
wherein the user terminal includes an imaging device, and
the retrieval condition image is imaged by the imaging device.

10. The merchandise retrieval device according claim 3,
wherein the user terminal includes an imaging device, and
the retrieval condition image is imaged by the imaging device.

11. The merchandise retrieval device according to claim 1,
wherein the retrieval condition image is selected from images stored in the user terminal.

12. The merchandise retrieval device according to claim 2,
wherein the retrieval condition image is selected from images stored in the user terminal.

13. The merchandise retrieval device according to claim 3,
wherein the retrieval condition image is selected from images stored in the user terminal.

14. The merchandise retrieval device according to claim 1,
wherein the user terminal presents some of a plurality of candidates regarding the design feature to a user, and receives at least one design feature designated by the user, and
the second retrieval unit determines the second retrieval condition data based on the design feature designated by the user from the plurality of candidates.

15. The merchandise retrieval device according to claim 2,
wherein the user terminal presents some of a plurality of candidates regarding the design feature to a user, and receives at least one design feature designated by the user, and
the second retrieval unit determines the second retrieval condition data based on the design feature designated by the user from the plurality of candidates.

16. The merchandise retrieval device according to claim 1,
wherein the database associates the plurality of merchandise images with metadata items including feature data indicating the design feature of each of the plurality of merchandise images, and stores the associated information items, and
the feature data items are acquired by an image analysis unit that analyzes the plurality of merchandise images.

17. The merchandise retrieval device according to claim 16,
wherein an external terminal device is connected to the database, and the metadata items stored in the database are able to be corrected through the external terminal device.

18. The merchandise retrieval device according to claim 17,
wherein at least some of the plurality of merchandise images are associated with the metadata items corrected through the external terminal device, and are stored in the database.

19. A merchandise retrieval method performed by a merchandise retrieval device connected to a user terminal via a network, the method comprising:
a step of analyzing a retrieval condition image to acquire first retrieval condition data indicating a design feature regarding at least one design element of the retrieval condition image, and automatically retrieving a plurality of first retrieval images from a plurality of merchandise images stored in a database based on the first retrieval condition data; and
a step of retrieving second retrieval images from the plurality of first retrieval images based on second retrieval condition data designated as being related to the design feature through the user terminal,
wherein images having the design feature, which are included in a first retrieval range determined using the first retrieval condition data as a criterion in a feature space representing the design feature, are retrieved from the plurality of merchandise images, as the first retrieval images,
images having the design feature, which are included in a second retrieval range determined using the second retrieval condition data as a criterion in the feature space, are retrieved from the plurality of first retrieval images, as the second retrieval images, and
the first retrieval range is larger than the second retrieval range, and the second retrieval range is included in the first retrieval range.

20. The merchandise retrieval device according to claim 1,
wherein in a case where the design element is color and the first retrieval condition data indicating the design feature is specified by a color palette number,
the first retrieval unit determines the first retrieval condition data based on the color palette number indicating the color of the retrieval condition image obtained by analyzing the image retrieval condition image, determines the first retrieval range determined by the first retrieval condition data in a feature space based on a color space, and selects images equivalent to the color palette number included in the first retrieval range as the first retrieval images.
